(19) United States
(12) Patent Application Publication
(10) Pub. No.: US 2002/0112309 A1
(43) Pub. Date: Aug. 22, 2002

(54) Vertical paint tray

(76) Inventor: Ronald Rougeau, Winnipeg (CA)

Correspondence Address: ADE & COMPANY, 1700-360 MAIN STREET, WINNIPEG, MB, R3C3Z3, CA

(21) Appl. No.: 09/785,295

(22) Filed: Feb. 20, 2001

(51) Int. Cl. B05C 21/00

(52) U.S. Cl. 15/257.06

(57) ABSTRACT

An apparatus for dispensing paint comprises a container arranged to contain paint, the container has an open top end of the container providing access to the paint by a user, an enclosed bottom end on the container and a front inner side of the container. The front inner side has a plurality of raised protrusions for rolling off excess paint of a paint roller. A mounting arrangement is located at the top end on a back side of the container for supporting the container in a raised position on a vertical structure. A supporting arrangement is located at the bottom end for supporting the container such that the container remains in a generally vertical position. The mounting arrangement is arranged such that the raised protrusions on the front inner side of the container face towards the user on the vertical structure.

### FIELD OF THE INVENTION

The present invention relates to a paint tray, more particularly a paint tray for use on a ladder or the like.

### BACKGROUND

Conventional paint trays used for roller type painting devices are flat pans which have a bottom reservoir wherein paint is contained and a ribbed angled portion wherein the roller is rolled to remove excess paint. These type of paint trays maybe useful when positioned in a stationary place such as a ground surface but may not be suitable for use on ladders. Since the trays have a reasonably large opening they may be susceptible to spillage when on a ladder which can cause a considerable mess to clean.

A number of Patents have been issued for paint trays which can be mounted on to a ladder or scaffold or can also be carried by an individual. Some examples of these paint trays are found in U.S. Pat. Nos. 5,493,751 (Misiukowiec et al), 5,836,043 (Rovas), 3,940,824 (Gioia et al), and 3,351,970 (Engh). These examples of paint trays have a generally vertical containing arrangement which allows a user to place the tray on a ladder or scaffold. These examples however, have a relatively large opening which may not contain the paint sufficiently thereby the paint within the container while in use may be spilled or splashed onto surrounding surfaces or areas.

Some other examples of paint trays are disclosed in U.S. Pat. Nos. 5,511,279 (Ippolito), 4,787,586 (Crain) and 3,837,034 (Leffert et al).

### SUMMARY

According to the present invention there is provided an apparatus for dispensing paint comprises:

a container arranged to contain paint;

an open top end of the container providing access to the paint by a user;

an enclosed bottom end on the container;

a front inner side of the container;

a plurality of raised protrusions on the front inner side;

a mounting arrangement located at the top end on a back side of the container for supporting the container in a raised position on a vertical structure;

a supporting arrangement located at the bottom end for supporting the container such that the container remains in a generally vertical position;

the mounting arrangement being arranged such that the raised protrusions on the front inner side of the container face towards the user on the vertical structure.

Preferably the front inner side is slightly angled inwards from the top end to the bottom end.

Preferably the mounting arrangement has a pair of tabs extending from a top end of the back side which are arranged to receive hooked ends of a cord.

Preferably the cord is arranged to wrap around the vertical structure.

Preferably the supporting arrangement has a clasp on the bottom end which is arranged to generally horizontally support an elongate member which is arranged to extend out from respective sides of the container for engaging the vertical structure.

Preferably the front inner side of the container is arranged to support a paint roller.

Preferably the top end is substantially larger in width in relation to the bottom end.

Preferably each side extends to substantially the same height at the top end.

Preferably a cradle is arranged to support the container.

Preferably the cradle has a clasp engaging member such that the container can be pivoted at the clasp within cradle.

Preferably the cradle is arranged to enclose the container therein.

Preferably the cradle is arranged to support the container in a generally vertical manner such that the container is accessible for a user on a horizontal surface.

### BRIEF DESCRIPTION OF THE DRAWINGS

In the accompanying drawings, which illustrate an exemplary embodiment of the present invention:

FIG. 1 is an isometric view of the present invention.

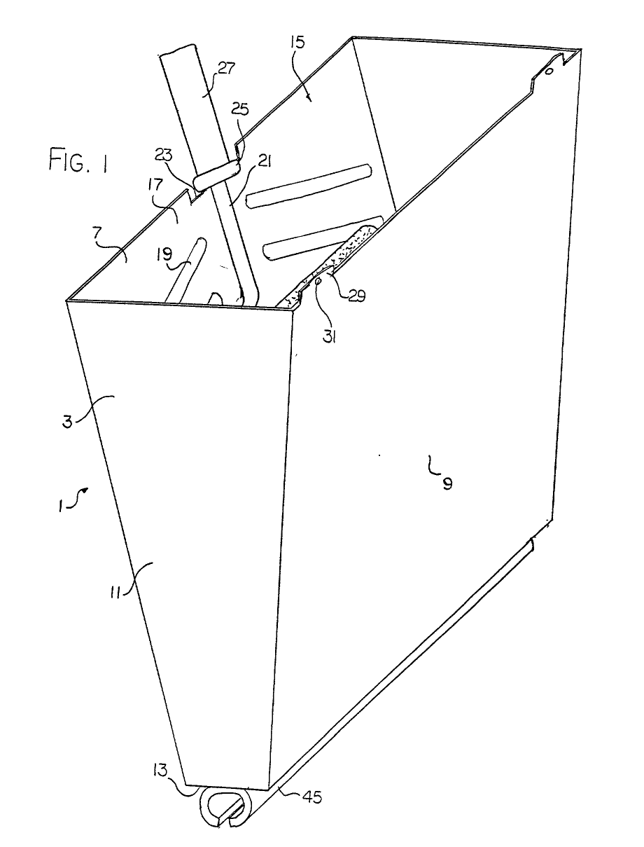

FIG. 2 is an isometric view of the present invention.

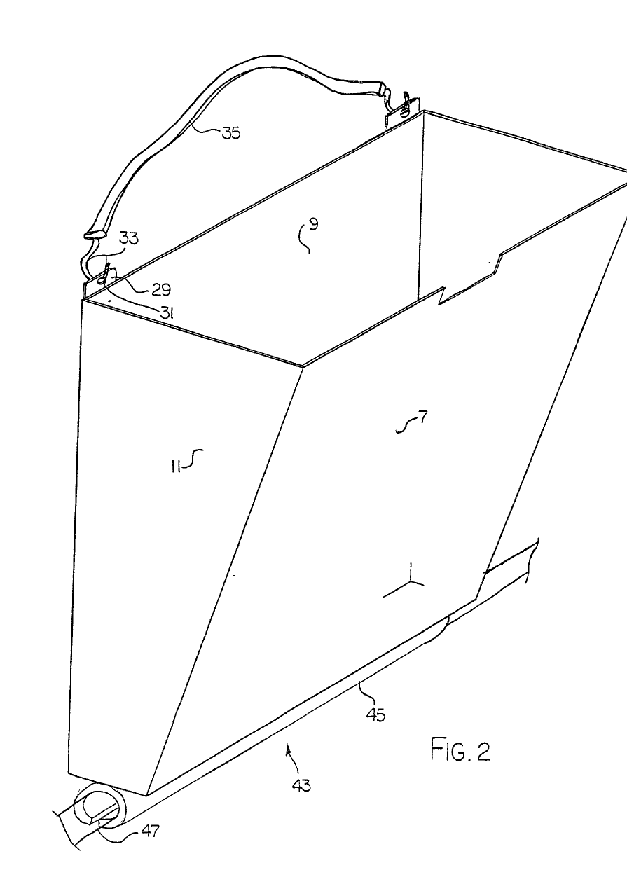

FIG. 3 is a front elevational view of the present invention.

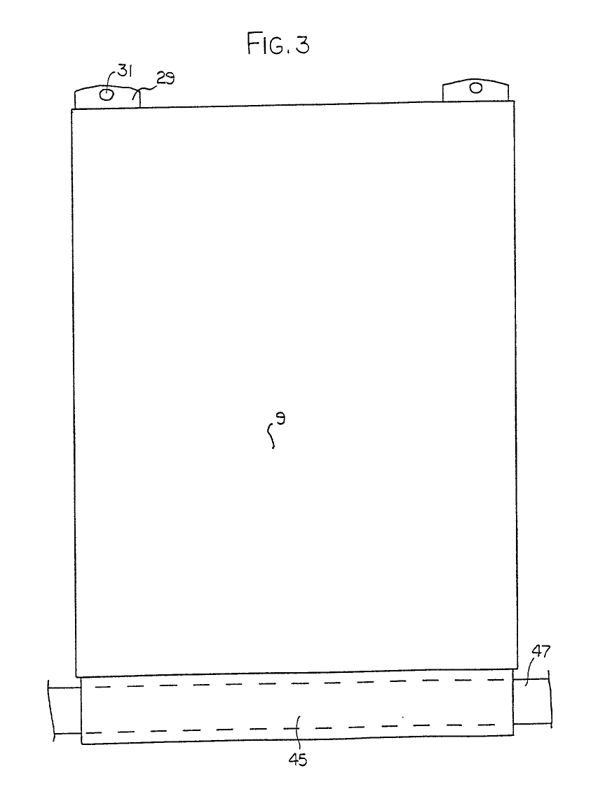

FIG. 4 is a side elevational view of the present invention.

FIG. 5 is a vertical cross section along the lines 5-5 of FIG. 1.

FIG. 6 is a side elevational view of the present invention.

FIG. 7 is a side elevational view of the present invention.

FIG. 8 is an isometric view of a second embodiment of the present invention.

### DETAILED DESCRIPTION

Referring to the accompanying drawings, there is illustrated an apparatus for dispensing paint 1. The apparatus utilises a container 3 which is arranged to contain paint 5. The container has a front wall 7, a back wall 9 and two side walls 11 connecting the front and back walls. The side walls are substantially triangular in shape such that the front wall extends downwards at an angle and the container has a bottom side 13 which encloses the container. The container has an open top end 15 which provides access to the paint within the container. The width at a top end between the front wall and the back wall is larger than the width at the bottom end between the front wall and the back wall. The height of each wall is substantially the same at the top end providing an enclosure so that paint does not spill or splash onto surrounding areas from within the container.

An inner surface 17 of the front wall has two rows of raised protrusions 19 which are used in association with a paint roller 21. The protrusions allow a user to roll the paint roller thereon so that excess paint is removed from the roller, as well known in the art. The raised protrusions are located within the container on the front wall so that the paint does not splash out of the container. The front wall has an indent 23 which is arranged to receive a lip 25 on the handle 27 of the roller. The indent allows a user to place the roller in the container without having to submerge the roller within the paint contained in the container.

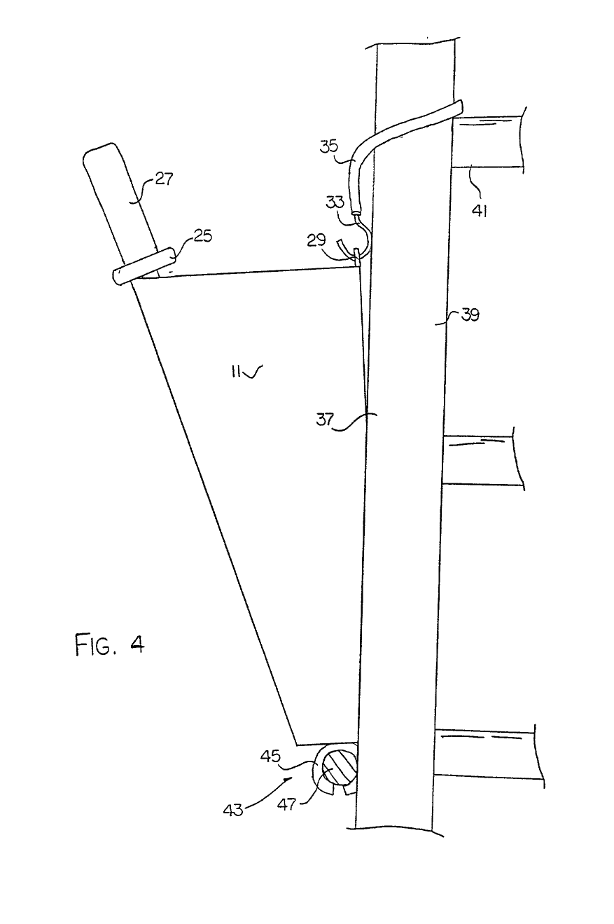

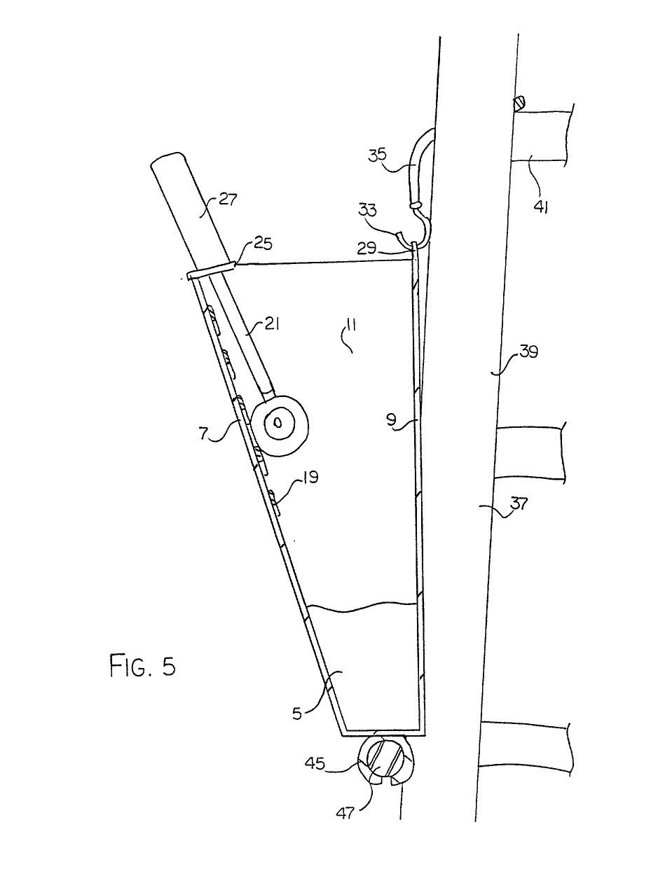

A pair of tabs 29 are located at the top end of the back wall adjacent a respective side wall. Each tab has a hook hole 31 each being arranged to receive a hook 33. Each hook is connected to an end of a bungee cord 35 which allows the container to be mounted to a ladder or scaffold 37. The bungee cord, as best shown in FIGS. 4 and 5 is wrapped around posts 39 of the ladder above a step 41 thereon such that the container can be hung from a ladder. Thus providing a user with access to the container while being positioned on a ladder.

The container is supported in a generally vertical manner on the ladder by a supporting arrangement 43. The supporting arrangement has a clasp 45 mounted on the bottom end of the container and is arranged to clasp a rod 47 which extends outwards past each side wall for engaging the post of the ladder prohibiting the container from swaying forwards and backwards. The clasp is arranged such that the rod can be an extension pole for the roller thereby allowing the user to have access to the desired tools while remaining on the ladder.

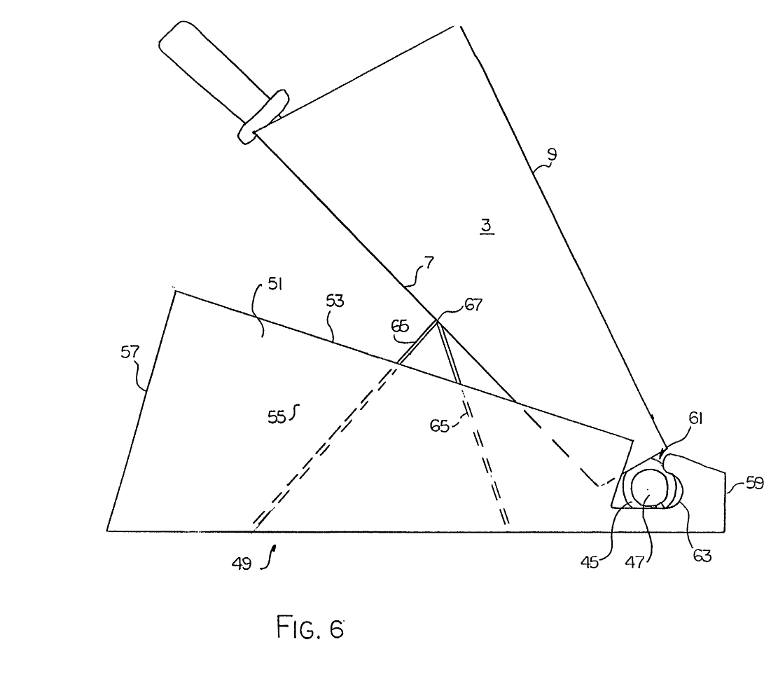

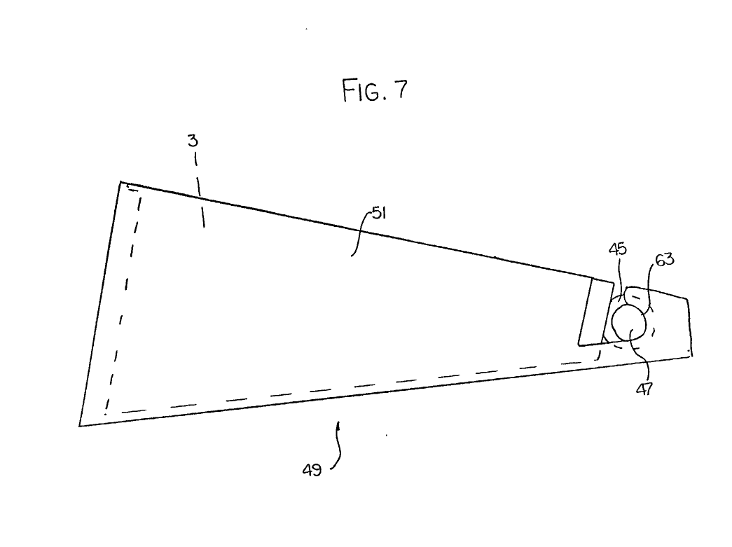

A cradle 49, as best shown in FIGS. 6 and 7, is arranged to support the container on a horizontal surface. The cradle has a main body 51 wherein the container is arranged to fit therein. The cradle has an open top portion 53, side walls 55, a front wall 57 and a back wall 59. Adjacent the back wall on each side wall is an insert portion 61. The insert portion is arranged to receive the rod supported by the clasp such that the container is pivotally connected thereto. The insert portion extends downwards and has a locking portion 63 which extends rearwards from the insert such that the container can be locked within the cradle.

A pair of support leafs 65 are pivotally mounted to an inner side of the bottom side of the cradle. The leafs are spaced apart such that the leafs can fold one on top of the other within the cradle when the container is positioned therein. The leafs can be pivoted upwards and connected at a top end 67 which provides a support for the front wall of the container. The leafs support the container in a generally upright position for use on a horizontal surface, as best shown in FIG. 6. FIG. 7 shows the container positioned within the cradle for storing and transport of the container prohibiting unnecessary spillage of the paint.

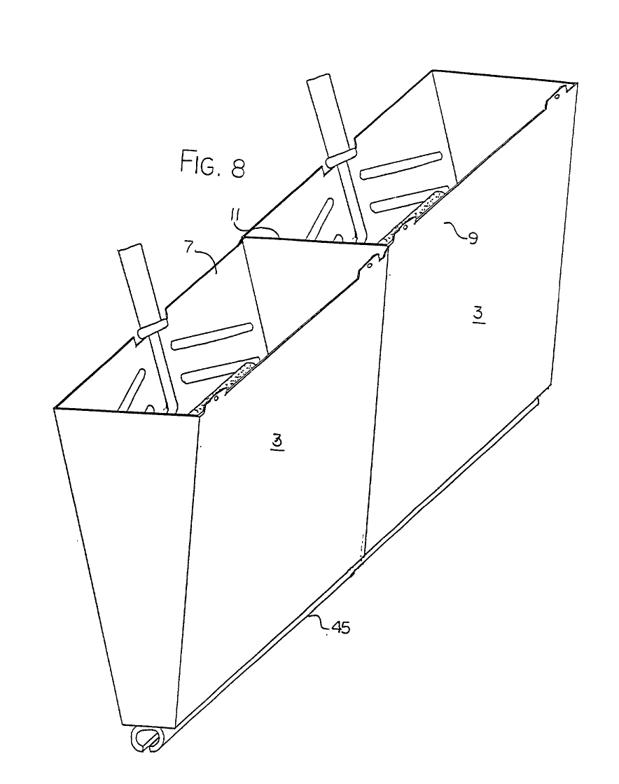

FIG. 8 shows an alternative embodiment of the apparatus wherein two containers are connected at respective side walls such that two different types/colours of paint can be used. The containers are divided by the respective side walls. The clasp extends along the length of the bottom side of the containers and each container has an indent for each paint roller.

While one embodiment of the present invention has been described in the foregoing, it is to be understood that other embodiments are possible within the scope of the invention. The invention is to be considered limited solely by the scope of the appended claims.

1. An apparatus for dispensing paint comprises:
a container arranged to contain paint;
an open top end of the container providing access to the paint by a user;
an enclosed bottom end on the container;
a front inner side of the container;
a plurality of raised protrusions on the front inner side;
a mounting arrangement located at the top end on a back side of the container for supporting the container in a raised position on a vertical structure;
a supporting arrangement located at the bottom end for supporting the container such that the container remains in a generally vertical position;
the mounting arrangement being arranged such that the raised protrusions on the front inner side of the container face towards the user on the vertical structure.

2. The apparatus according to claim 1 wherein the front inner side is slightly angled inwards from the top end to the bottom end.

3. The apparatus according to claim 1 wherein the mounting arrangement has a pair of tabs extending from a top end of the back side which are arranged to receive hooked ends of a cord.

4. The apparatus according to claim 3 wherein the cord is arranged to wrap around the vertical structure.

5. The apparatus according to claim 1 wherein the supporting arrangement has a clasp on the bottom end which is arranged to generally horizontally support an elongate member which is arranged to extend out from respective sides of the container for engaging the vertical structure.

6. The apparatus according to claim 1 wherein the front inner side of the container is arranged to support a paint roller.

7. The apparatus according to claim 1 wherein top end is substantially larger in width in relation to the bottom end.

8. The apparatus according to claim 1 wherein each side extends to substantially the same height at the top end.

9. The apparatus according to claim 1 wherein a cradle is arranged to support the container.

10. The apparatus according to claim 9 wherein the cradle has a clasp engaging member such that the container can be pivoted at the clasp within cradle.

11. The apparatus according to claim 9 wherein the cradle is arranged to enclose the container therein.

12. The apparatus according to claim 9 wherein the cradle is arranged to support the container in a generally vertical manner such that the container is accessible for a user on a horizontal surface.
